(19) United States
(12) Patent Application Publication
(10) Pub. No.: US 2026/0163225 A1
(43) Pub. Date: Jun. 11, 2026

(54) A COOLING MODULE FOR COOLING HEAT GENERATING COMPONENTS OF HIGH-FREQUENCY ANTENNA ARRAYS

(71) Applicant: SAAB AB, Linköping (SE)

(72) Inventors: Martin BLENNIUS, Kullavik (SE); Hans FALK, Mölndal (SE)

(21) Appl. No.: 18/709,654

(22) PCT Filed: Nov. 16, 2022
(86) PCT No.: PCT/SE2022/051071

§ 371 Date: May 13, 2024

(30) Foreign Application Priority Data
Nov. 18, 2021 (SE) 2100174-8

(51) Int. Cl. H01Q 1/02

(52) U.S. Cl. CPC H01Q 1/02

(57) ABSTRACT

The present disclosure relates to a cooling system for cooling heat generating components of high-frequency antenna arrays including a first plate, a second plate and an intermediate plate. Further, the cooling system forms a first flow portion in-between the first and the intermediate plate, and a second flow portion in-between the second and the intermediate plate. The cooling system further includes an inlet and an outlet positioned at a proximal area of said cooling system, wherein the inlet is connected to the first flow portion and the outlet is connected to the second flow portion. Moreover, an overflow portion merges a part of said first and second flow portion at a distal area of said cooling system and at least one thermally conductive rod.

### TECHNICAL FIELD

The present disclosure relates to a cooling module for cooling heat generating components of high-frequency antenna arrays and a high-frequency equipment comprising the same.

### BACKGROUND ART

Antenna arrays with a set of two or more antenna elements are commonly used in various applications to combine or process signals from the antenna array in order to achieve improved performance over that of a single antenna.

High-frequency AESA (active electronically scanned arrays) arrays, specifically in x-band, comprise tightly packed antenna elements which commonly have high heat loss leading to high effect power flow while also having a limited access to cooling medium and space.

Currently, a common way of cooling heat generating components is to provide cooling modules placed in close vicinity to the heat generating component where a parallel cooling flow is applied in said cooling module to cool the heat generating component. A problem with such a cooling method is that it is challenging to obtain an even cooling over the total area of the heat generating component which is problematic specifically when the heat generating components span over a large area and/or are tightly packed.

Based on the above there is in the present art room for improvements in order to have cooling modules that are able to cool heat generating components in a more efficient manner and that is suitable for heat generating components that span over a large area and/or are tightly packed.

Even though some currently known solutions work well in some situations it would be desirable to provide a cooling module that specifically fulfils requirements relating to efficiency in the cooling process.

### SUMMARY

It is therefore an object of the present disclosure to provide a cooling module, a high-frequency equipment comprising a cooling module and a system in order to mitigate, alleviate or eliminate one or more of the above-identified deficiencies and disadvantages.

This object is achieved by means of a cooling module as defined in the appended claims. The present disclosure is at least partly based on the insight that by providing a cooling module that allows for efficient and flexible cooling over large areas, the cooling modules will be improved in terms of having a better performance, and be generally more efficient in their functioning.

The present disclosure provides a cooling module (device/unit) for cooling heat generating components of high-frequency antenna arrays. The cooling module comprises a first plate, a second plate and an intermediate plate in-between the first and the second plate. The cooling module forms a first flow portion in-between the first and the intermediate plate and a second flow portion in-between the second and the intermediate plate, each plate extending parallel relative each other, in a first and a second direction. Further, an inlet and an outlet are positioned at a proximal area of said cooling module wherein the inlet is connected to the first flow portion and the outlet is connected to the second flow portion. Further, an overflow portion merges a part of said first and second flow portion at a distal area of said cooling module. Moreover, at least one thermally conductive rod, extends at least in-between two plates of the first, intermediate and the second plate. The cooling module is arranged to transfer a cooling medium from the inlet through the first flow portion in a first direction, to the outlet from the second flow portion in a direction opposite to the first direction, wherein said overflow portion allows for the cooling medium to transfer the cooling medium from the first to the second flow portion.

An advantage of the cooling module is that it, by having three plates provides two cool fronts (i.e. the flow portions), which allows for a more efficient and flexible cooling of heat generating components. Moreover, the cooling medium can, by having two cooperating cool fronts, cool large areas evenly. Further, the conductive rods allows the cooling module to adapt the cooling in different areas of each cool front i.e. control the cooling of the first and second flow portion. Further, the overflow portion allows for cooling medium to transfer from the first to the second flow portion. An additional advantage by having the cooling medium to flow between to flow portions that have a common intermediate plate is that there is possibility to compensate for power losses by controlling the cooling of the flow portions relative each other.

The first and second flow portions may extend along the width (in the second direction) of the first, second and intermediate plates and along a length (in the first direction) thereof. Accordingly, the first and second flow portion may be channel-free, each flow portion forming a rectangular flow trajectory, thereby a larger area of the cooling module can be cooled. Channel-free may refer to that there are no channels for transferring the cooling medium, instead the cooling medium is transferred along a free space within each flow portion which is constrained wherein each flow portion is constrained in the second direction by side walls of the cooling module, thereby allowing the cooling medium to be distributed along substantially the full area of the cooling module in the first and second direction.

Further, at least one of the first and the second plate may be arranged to be in contact with a heat generating component. Thus, allowing for conductive cooling of the heat generating component.

Further, the cooling module may comprise a plurality of throttle means associated with said proximal area arranged to steer said cooling medium when circulating in said first and second flow portion. The throttle means are arranged to steer the cooling medium within a flow portion. Thus, the throttle means may redistribute the flow of water from e.g. the inlet evenly along the flow portion so to provide for even cooling of a large area. The throttle means may be associated with the inlet and/or outlet of the cooling module.

The cooling module may further comprise an underpressure means arranged to create/have/provide an underpressure relative the at least one of the first and the second flow portion when a flow of cooling medium is transferred in said cooling module.

The underpressure means may be an air-channel connected to the overflow portion, the first flow portion and/or the second flow portion and extend towards said outlet or said inlet. The underpressure means allows excess air within the cooling module to be removed from the module, allowing for a self-venting cooling module. The underpressure means may be connected to any portion of the distal area of said cooling module and extend towards the outlet or the inlet.

The first, second and intermediate plate may be made in metal.

The intermediate plate may comprise two surfaces, each associated to a respective flow portion, wherein the surfaces are arranged to transfer cooling medium in opposing directions relative each other. Thus, the intermediate plate allows for controlling/redirecting the temperature of the two flow portions.

There is further provided a system comprising the cooling module in accordance with the present disclosure and a reservoir module and a pump configured to eject said cooling medium to flow from the reservoir module and circulate through the inlet, first flow portion, second flow portion and the outlet. Accordingly, allowing for the cooling medium to circulate and cool heat generating components.

There is further provided a high-frequency equipment comprising the cooling module in accordance with the present disclosure. The high-frequency equipment may be attached to the first and/or the second plate. The high-frequency equipment may be a phased array antenna e.g. a AESA antenna, or any other form of antenna.

### BRIEF DESCRIPTION OF THE DRAWINGS

In the following the disclosure will be described in a non-limiting way and in more detail with reference to exemplary embodiments illustrated in the enclosed drawings, in which:

FIG. 1 illustrates the cooling module from a side-view in accordance with an embodiment of the present disclosure;

FIG. 2 illustrates the cooling module from an objective view in accordance with an embodiment of the present disclosure;

FIG. 3A illustrates a part of the cooling module from an objective view in accordance with an embodiment of the present disclosure;

FIG. 3B illustrates a part of the cooling module from an objective view in accordance with an embodiment of the present disclosure;

FIG. 4 illustrates a front cross-sectional view of the cooling module in accordance with an embodiments of the present disclosure;

FIG. 5 illustrates a front cross-sectional view of the cooling module in accordance with an embodiment of the present disclosure;

FIG. 6A schematically illustrates a cooling system comprising a cooling module in accordance with an embodiment of the present disclosure

FIG. 6B schematically illustrates a high-frequency equipment comprising a cooling module in accordance with an embodiment of the present disclosure

### DETAILED DESCRIPTION

In the following detailed description, some embodiments of the present disclosure will be described. However, it is to be understood that features of the different embodiments are exchangeable between the embodiments and may be combined in different ways, unless anything else is specifically indicated. Even though in the following description, numerous specific details are set forth to provide a more thorough understanding of the provided module, it will be apparent to one skilled in the art that the module may be realized without these details. In other instances, well known constructions or functions are not described in detail, so as not to obscure the present disclosure.

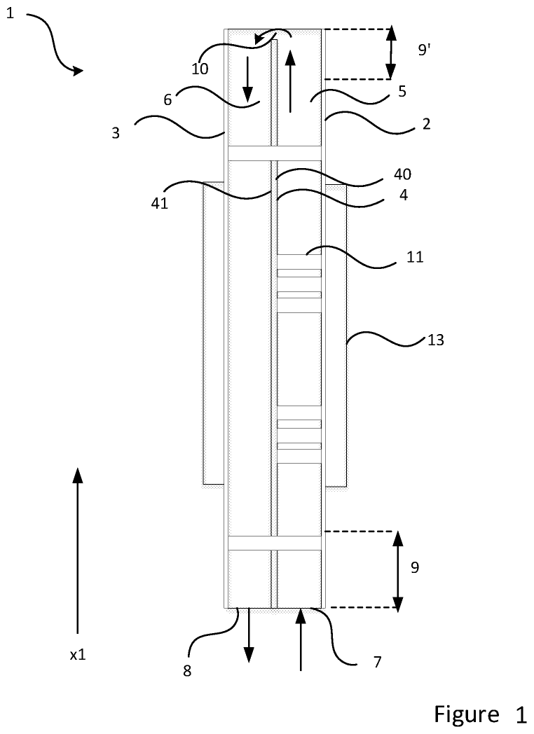

FIG. 1 illustrates a side cross-sectional view of a cooling module 1 for cooling heat generating components of high-frequency antenna arrays. The cooling module 1 comprising a first plate 2, a second plate 3 and an intermediate plate 4 in-between the first and the second plate 2, 3, wherein said cooling module 1 forms a first flow portion 5 in-between the first and the intermediate plate 2, 4, and a second flow portion 6 in-between the second and the intermediate plate 3, 4, each plate extending parallel relative each other, in a first and a second direction x1, x2. The cooling module 1 further comprises an inlet 7 and an outlet 8 positioned at a proximal area 9 of said cooling module 1, wherein the inlet 7 is connected to the first flow portion 5 and the outlet 8 is connected to the second flow portion 6. Further, the cooling module 1 comprises an overflow portion 10 merging a part of said first and second flow portion 5, 6 at a distal area 9′ of said cooling module 1.

In some embodiments, the inlet and outlet 7, 8 are positioned in different areas. The overflow portion 10 allows for cooling medium to flow from the first to the second flow portion 5, 6 or vice versa. Thus, allowing for parallel cooling. Further, the cooling module 1 comprises at least one thermally conductive rod 11, each rod 11 extending at least in-between two plates of the first, intermediate and the second plate 2, 3, 4.

Thus, the thermally conductive rods 11 allows for redirecting temperatures (heat/cold) in between the first and second flow portion 5, 6. Further, the cooling module 1 is arranged to transfer a cooling medium from the inlet 7 through the first flow portion 5 in a first direction x1, to the outlet 8 from the second flow portion 6 in a direction opposite to the first direction x1, wherein said overflow portion 10 allows for the cooling medium to transfer the cooling medium from the first to the second flow portion 5, 6. Thus, allowing for parallel cooling by cooling medium flowing in-between first and second flow portion 4, 5.

As illustrated in FIG. 1, at least one of the first 2 and the second plate 3 is arranged to be in contact with a heat generating component 13. A heat generating component 13 may be e.g. the circuitry of an antenna array.

Further, the first, second, and the intermediate plate 2, 3, 4 may be made in a metal, preferably copper or aluminium, or any other suitable thermally conductive material.

As further shown in FIG. 1, the intermediate plate 4 comprises two surfaces 40, 41, each associated to a respective flow portion 5, 6, wherein the surfaces 40, 41 are arranged to transfer (or facilitate the transfer of) cooling medium in opposing directions relative each other. Thus, the surface 40 transfers cooling medium in a first direction x1, wherein the surface 41 transfers cooling medium in an opposite direction to the first direction x1.

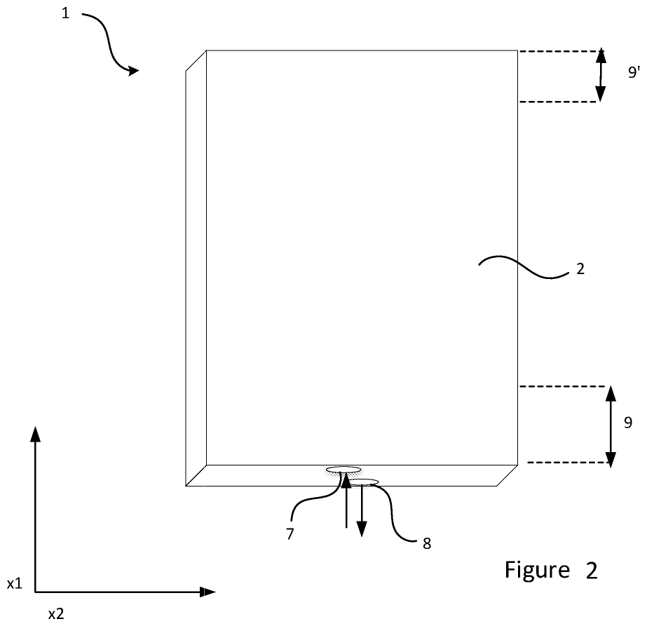

FIG. 2 illustrates an objective view of a cooling module 1 illustrating that the inlet 7 and outlet 8 are located on a common portion (the proximal area 9) of the cooling module 1. Thus, the module 1 is configured to transfer cooling medium from the inlet 7 towards the distal area 9′, where the overflow portion (shown in FIG. 1) allows it to be redirected towards the outlet 8.

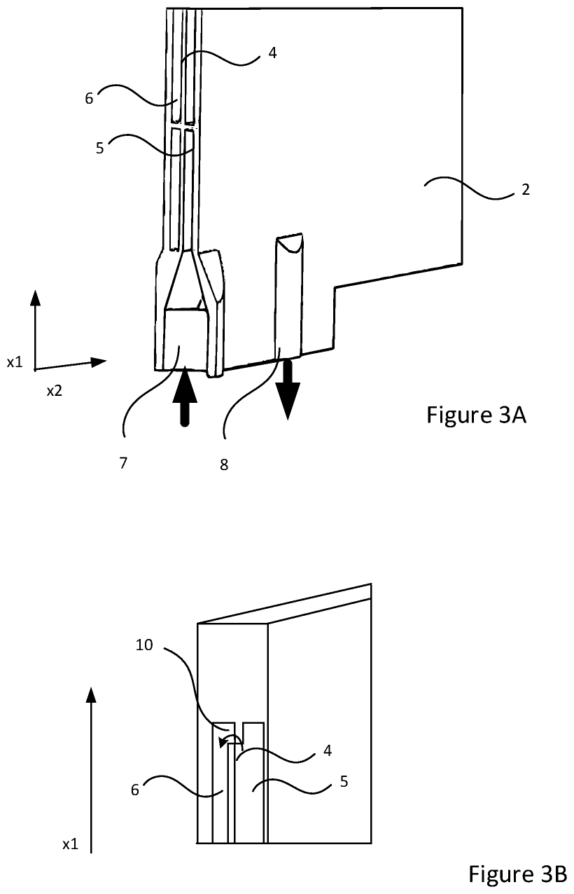

FIG. 3A illustrates a part of the proximal area 9 of the cooling module 1 from an objective cross-sectional view. Specifically illustrating how the inlet 7 leads to the first flow portion 5.

FIG. 3B illustrates a part of the distal area 9′ of the cooling module 1 from an objective cross-sectional view. FIG. 3B specifically illustrates the overflow portion 10 that allows the cooling medium to flow from the first flow portion 5 to the second flow portion 6. The overflow portion 10 may be defined by a slit/cavity in the distal portion 9′ of the intermediate plate 4, or any other suitable means that allow for cooling medium to overflow from the first flow portion 5 to the second 6.

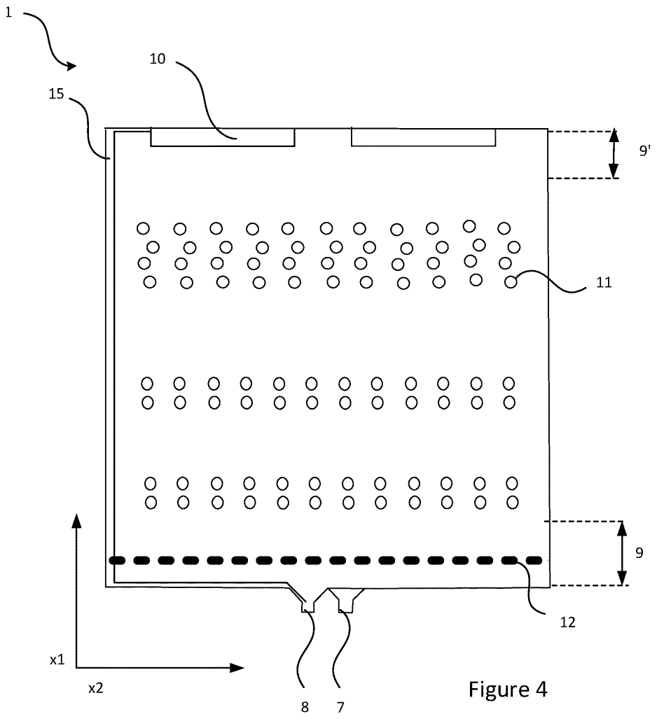

FIG. 4 illustrates a front cross-sectional view of the cooling module 1, as shown in FIG. 4, the thermally conductive rods 11 may be spread in different formations over the cooling module 1 in the first and the second direction x1, x2 in order to allow for controlling the temperature of both the first and the second plate 2, 3 that are parallel to each other.

FIG. 4 illustrates that the cooling module 1 comprises, at said proximal portion 9 a plurality of throttle means 12 arranged to strangle the flow of cooling medium associated to the inlet 7 in order to allow the cooling medium to be spread along the second direction x2 of the cooling medium to obtain an even cooling of the whole surface. In other words, the throttle means 12 that are associated with said proximal area 9, may be arranged to steer/spread said cooling medium when circulating in said first and second flow portion 5, 6. Thus, allowing cooling medium inputted from one point to be distributed over a large area.

Further, FIG. 4 shows that the cooling module comprises an underpressure means 15 arranged to create/have an underpressure (in relation to the pressure in at least a part of the cooling module 1) in at least one of the first and the second 5, 6 flow portion when a flow of cooling medium is transferred in said cooling module 1. The underpressure may provide an airpressure being lower than the pressure in the cooling module 1 so to draw out excess air. The underpressure created may be lower than atmospheric pressure. Thus, the term “underpressure” may refer to a pressure that is lower than the pressure in the first and the second flow portion 5, 6.

In FIG. 4, underpressure means 15 is an air-channel extending from the overflow portion 10 towards said outlet 8. In some embodiments, a venturi nozzle may be attached to the cooling module 1 to facilitate the underpressure.

Moreover, FIG. 4 shows that the overflow portion 10 may be varied in accordance with the present disclosure, e.g. in FIG. 4 it's divided into two parts.

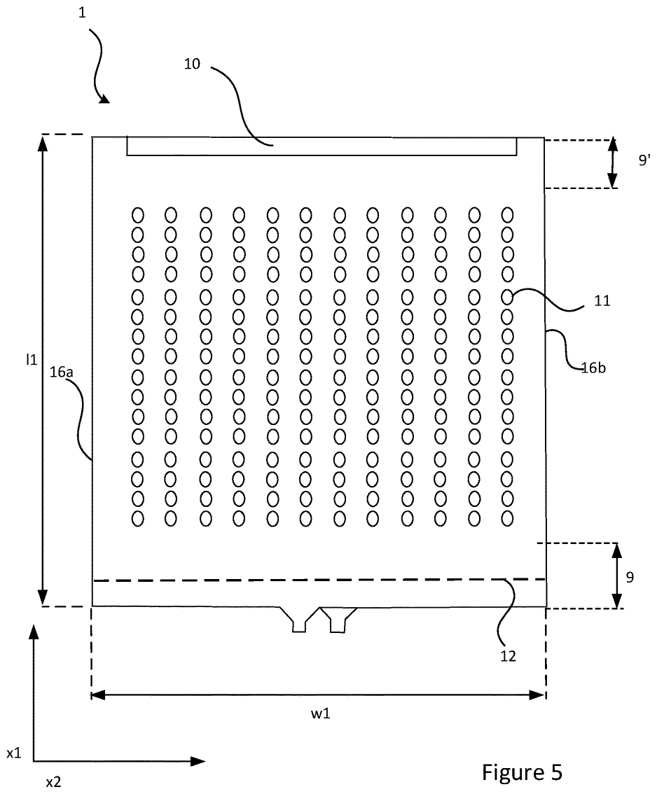

FIG. 5 illustrates a front cross-sectional view of the cooling module 1 according to some embodiments where the thermally conductive rods 11 have a different arrangement compared to the arrangement of the thermally conductive rods 11 shown in FIG. 4. It should be noted that the number of thermally conductive rods 11 may vary, however, there are preferably more than 5 rods, more preferably more than 10 rods. Moreover, the overflow portion 10 is also varied compared to the overflow portion in FIG. 4. Thus, the cooling module 1 may be varied in accordance with any embodiment of the present disclosure.

FIG. 5 further illustrates that the first and second flow portions may extend along the width w1 (in the second direction x2) of the first 2, second 3 and intermediate plates 4 and along a length 11 (in the first direction x1) thereof. Accordingly, the first and second flow portion 5, 6 may be channel-free, each flow portion 5, 6 forming a rectangular flow trajectory, thereby a larger area of the cooling module 1 can be cooled. Channel-free may refer to that there are no channels for transferring the cooling medium, instead the cooling medium is transferred along a free space within each flow portion 5, 6 which along the second direction x2 is constrained side walls 16a, 16b of the cooling module, thus cooling medium may extend between said side walls 16a, 16b. Each side wall 16a, 16b extending in a first direction x1. The distribution of cooling medium may be enhanced by having throttle means 12 in the proximal portion 9 of the cooling module 1.

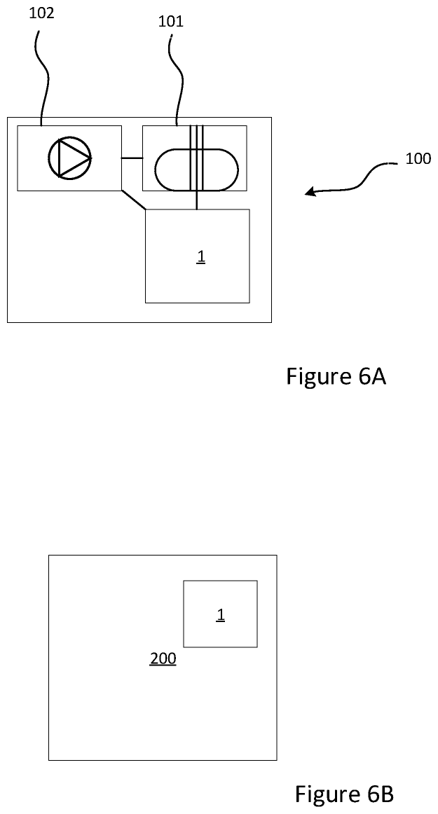

FIG. 6A schematically illustrates a cooling system 100 for cooling heat generating components of high-frequency antenna arrays. The cooling system 100 comprising the cooling module 1 according to any aspect of the present disclosure, a reservoir module 101, and a pump 102 configured to eject said cooling medium to flow from the reservoir module 101 and circulate through the inlet, first flow portion, second flow portion towards the outlet of the cooling module 1.

FIG. 6B schematically illustrates a high-frequency equipment 200 comprising the cooling module 1 according to any aspect herein. The high-frequency equipment 200 may be an AESA antenna array, a base station, or any other type of antenna or antenna array.

1. A cooling system for cooling heat generating components of high-frequency antenna arrays comprising:
a first plate, a second plate and an intermediate plate in-between the first and the second plate, wherein said cooling system forms a first flow portion in-between the first and the intermediate plate, and a second flow portion in-between the second and the intermediate plate, each plate extending parallel relative each other, in a first and a second direction;
an inlet and an outlet positioned at a proximal area of said cooling system, wherein the inlet is connected to the first flow portion and the outlet is connected to the second flow portion;
an overflow portion merging a part of said first flow portion and second flow portion at a distal area of said cooling system; and
at least one thermally conductive rod, each rod extending at least in-between two plates of the first, intermediate and the second plate;
wherein the cooling system is arranged to transfer a cooling medium from the inlet through the first flow portion in a first direction, to the outlet from the second flow portion in a direction opposite to the first direction, wherein said overflow portion allows for the cooling medium to transfer the cooling medium from the first to the second flow portion.

2. The cooling system according to claim 1, wherein at least one of the first and the second plate is arranged to be in contact with a heat generating component.

3. The cooling system according to claim 1, further comprising a plurality of throttle means associated with said proximal area arranged to steer said cooling medium when circulating in said first and second flow portion.

4. The cooling system according to claim 1, further comprising an underpressure means arranged to create an under pressure relative the first and the second flow portion when a flow of cooling medium is transferred in said cooling system.

5. The cooling system according to claim 3, wherein the underpressure means is an air-channel extending from said distal area towards said outlet or said inlet.

6. The cooling system according to claim 1, wherein the first, second and intermediate plate are made of metal.

7. The cooling system according to claim 1, wherein the intermediate plate comprises two surfaces, each associated to a respective flow portion, wherein the surfaces are arranged to transfer cooling medium in opposing directions relative each other.

8. The cooling system according to claim 1, wherein each flow portion is constrained in the second direction by side walls of the cooling system.

9. The cooling system according to claim 1, wherein each flow portion is channel-free.

10. The cooling system according to claim 1, further comprising:
a reservoir; and
a pump configured to eject said cooling medium to flow from the reservoir and circulate through the inlet, first flow portion, second flow portion towards the outlet of the cooling system.

11. A high-frequency equipment comprising the cooling system according to claim 1.
